(19) United States
(12) Patent Application Publication
(10) Pub. No.: US 2025/0115176 A1
(43) Pub. Date: Apr. 10, 2025

(54) Arrangement for Providing a Means of Attachment for a Vehicle Component

(71) Applicant: Illinois Tool Works Inc., Glenview, IL (US)

(72) Inventor: Marek KUKUCZKA, Istebna (PL)

(21) Appl. No.: 18/908,348

(22) Filed: Oct. 7, 2024

(30) Foreign Application Priority Data
Oct. 10, 2023 (DE) 10 2023 127 656.5

(51) Int. Cl. B60N 3/02

(52) U.S. Cl. CPC B60N 3/026

(57) ABSTRACT

The disclosure relates to an assembly (1) for providing a fastening possibility for a vehicle component to a body component (11). The assembly (1) includes a connecting element (2) and a retaining element (3). The retaining element (3) includes a base body having a retaining region (4), and the connecting element (2) includes a base body having a receiving region (5), in which at least the retaining region (4) of the retaining element (3) is received in a rotatable manner relative to the receiving region (5) about an axis of rotation. The assembly (1) can be transferred from a pre-assembly or deliverable state into an assembled state. In the pre-assembly or deliverable state of the assembly (1), the retaining element (3) lies in a first rotational position relative to the receiving region (5) of the connecting element (2) counter to a torsion torque serving as a biasing force and exerted by a biased torsion spring (6) on the retaining element (3), wherein, in the assembled state of the assembly (1), the retaining element (3) lies in a second rotational position that is different from the first rotational position. Due to an external pulse or trigger exerted on the retaining element (3), the assembly (1) can be transferred from its pre-assembly or deliverable state into its assembled state. When the assembly (1) is transferred from its pre-assembly or deliverable state into its assembled state, the retaining element (3) is at least partially transferred into the second rotational position due to the force of the torsion spring (6).

### RELATED APPLICATION

The present application claims the benefit of German Patent Application No. 10 2023 127 656.5, filed Oct. 10, 2023, titled “Arrangement for Providing a Means of Attachment for a Vehicle Component,” the contents of which are hereby incorporated by reference.

### BACKGROUND

Vehicle grab handles are provided in passenger cars, trucks, and sports cars for the purpose of providing support to occupants upon entering and exiting the vehicle. Vehicle grab handles can be static or dynamic. Dynamic grab handles can be moved between an extended position and a retracted position. Static grab handles, on the other hand, are fixedly attached, for example to the headliner of a vehicle.

Typically, vehicle grab handles are supplied parts, which are then mounted to a vehicle body in the simplest possible manner.

A wide variety of designs for vehicle grab handles are known. Currently available vehicle grab handles can be attached to the roof through the headliner or can be attached to one of the roof support pillars, which are known as the A-, B-, or C-pillar, either directly or via a trim part. The A-pillar is the roof support pillar located between the windshield and the window of the first row of seats. The B-pillar is the roof support pillar between the front and rear door or, in a coupe, the pillar which is located behind the doors of the vehicle. The C-pillar is the roof support pillar located between the rear door and the taillight of the vehicle.

The mounting/fastening of vehicle grab handles is usually carried out by means of a snap-in process. For this purpose, at least one fastening clip of the vehicle grab handle is commonly inserted into a provided fastening opening of a vehicle body component and fastened there. It is customary to cover the region of the fastening opening with cover caps or similar covers, so that it is no longer visible from the interior of the vehicle. The vehicle grab handles or the handle pieces belonging to the vehicle grab handles can be arranged in handle recesses provided for this purpose, so that a substantially flush surface is obtained, and the handle piece of the vehicle grab handle can nevertheless be grabbed comfortably.

To fasten a vehicle grab handle to a vehicle body component, it is known, for example from publication EP 1 084 908 A2, to insert a screw through an opening of the grab handle, wherein a fastening clip having a passage opening is inserted through openings of the grab handle and the headliner. At the end of the passage opening, there is a short piece of internal threading, which accommodates the screw in the pre-assembly position. By means of the fastening clip, which is supported on the rear of the headliner, and the screw, the grab handle and the headliner are held together in the pre-assembly unit in the pre-assembly position. In order to accommodate the screw, a weld nut is provided on the vehicle frame or body-side mounted portion formed as the base part.

In this approach according to the prior art, however, the fact that, for the final assembly of the pre-assembly unit, an additional component is required as a third fastening element, which must be attached in a laborious separate work step, has proven to be disadvantageous. Due to the positionally fixed attachment of the weld nut, a tolerance-based deviation of the screw-on points on the pre-assembly unit on the body-side mounted portion cannot be compensated. Additional solutions for accommodating tolerances on the trim part must therefore be realized. The screw-on point on the vehicle frame must likewise be located in an accessible location, wherein it is technically possible to attach the weld nut.

### SUMMARY

The present disclosure relates generally to fastening techniques, substantially as illustrated by and described in connection with at least one of the figures, as set forth more completely in the claims. More specifically, the present disclosure relates to an optimized fastening possibility, for fastening a vehicle grab handle or an airbag, to a body-side mounted portion, in the automotive sector. The body-side mounted portion is also referred to here as a “vehicle body component.”

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 illustrates schematically and in an isometric view, a first exemplary embodiment of the assembly according to the disclosure in its pre-assembly or deliverable state.

FIG. 2 illustrates schematically and in an isometric view, the first exemplary embodiment of the assembly according to the disclosure according to FIG. 1 in an exploded view.

FIG. 3 illustrates schematically and in an isometric view, the first exemplary embodiment of the assembly according to the disclosure in its assembled state.

FIG. 4 illustrates schematically and in a first isometric view, the retaining element of the first exemplary embodiment of the assembly according to the disclosure according to FIG. 1.

FIG. 5 illustrates schematically and in a second isometric view, the retaining element of the first exemplary embodiment of the assembly according to the disclosure according to FIG. 1.

FIG. 6 illustrates schematically and in an isometric view, the connecting element of the first exemplary embodiment of the assembly according to the disclosure according to FIG. 1.

FIG. 7 illustrates schematically and in an isometric view, the cover of the first exemplary embodiment of the assembly according to the disclosure according to FIG. 1.

FIG. 8 illustrates schematically and in an isometric view, the cover of the first exemplary embodiment of the assembly according to the disclosure in its state when connected to the retaining element, namely in the pre-assembly or deliverable state of the assembly.

FIG. 9 illustrates schematically and in a lateral view as well as in an isometric view, a second exemplary embodiment of the assembly according to the disclosure in its pre-assembly or deliverable state.

FIG. 10 illustrates schematically and in a lateral view as well as in an isometric view, the second exemplary embodiment of the assembly according to the disclosure in its assembled state.

FIG. 11 illustrates schematically and in an isometric exploded view, the second exemplary embodiment of the assembly according to the disclosure.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

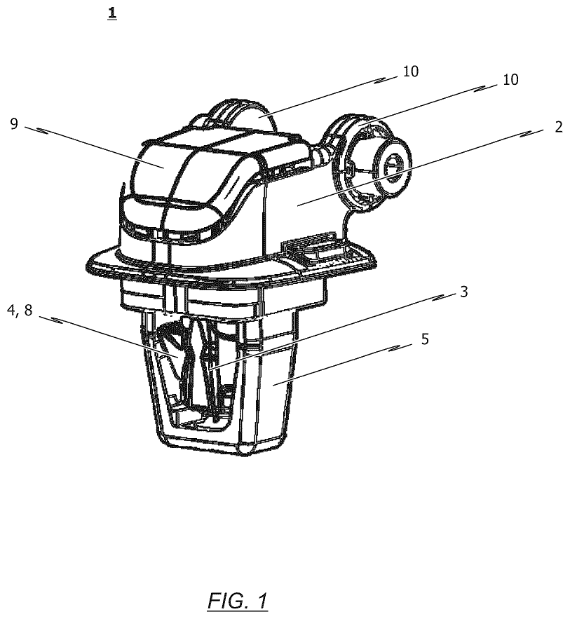

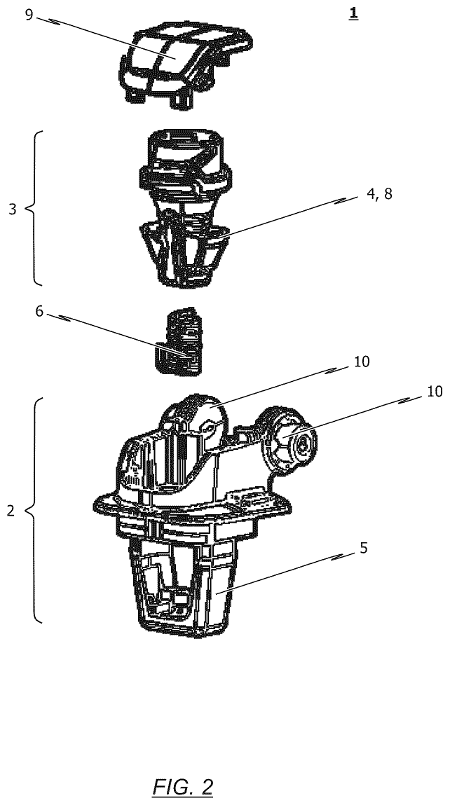

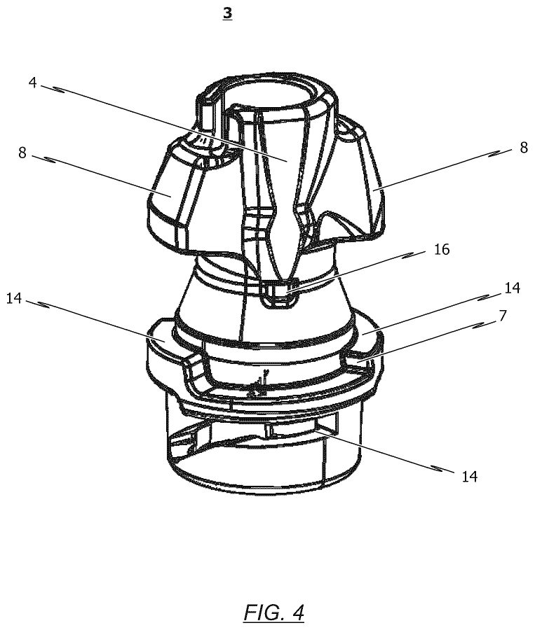

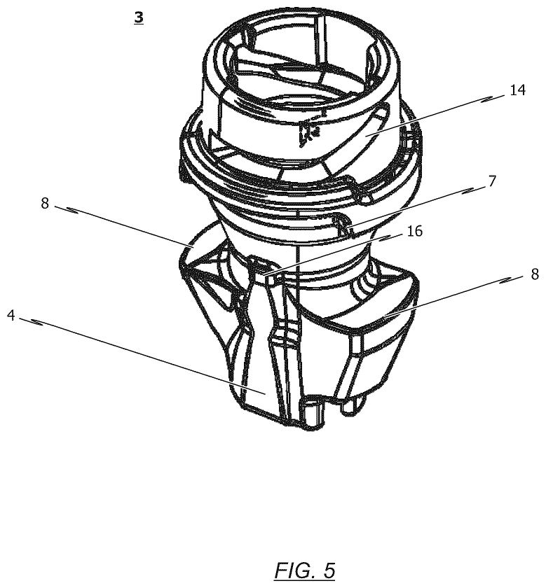

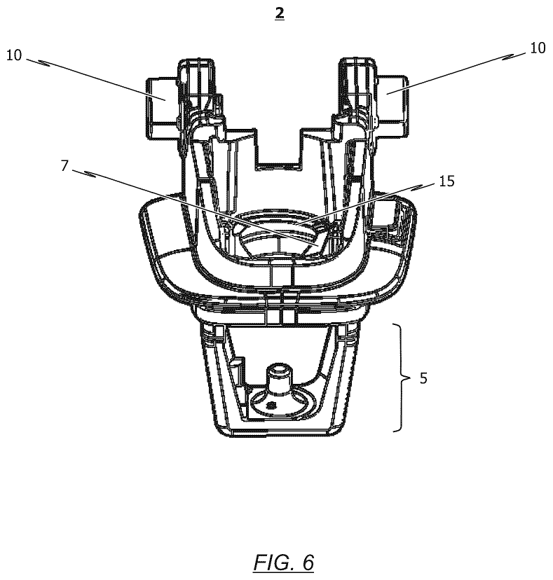

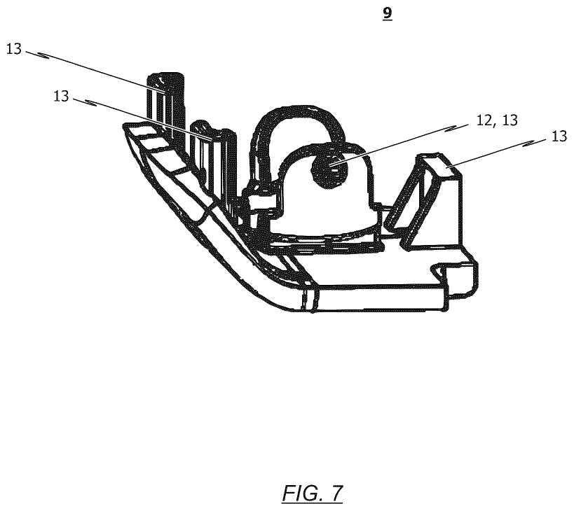

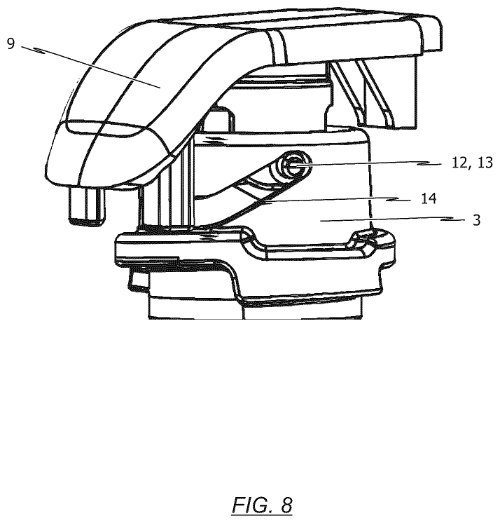

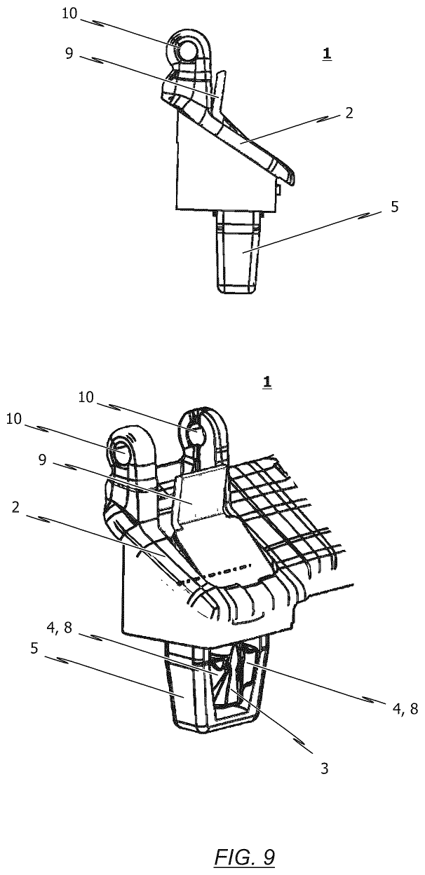

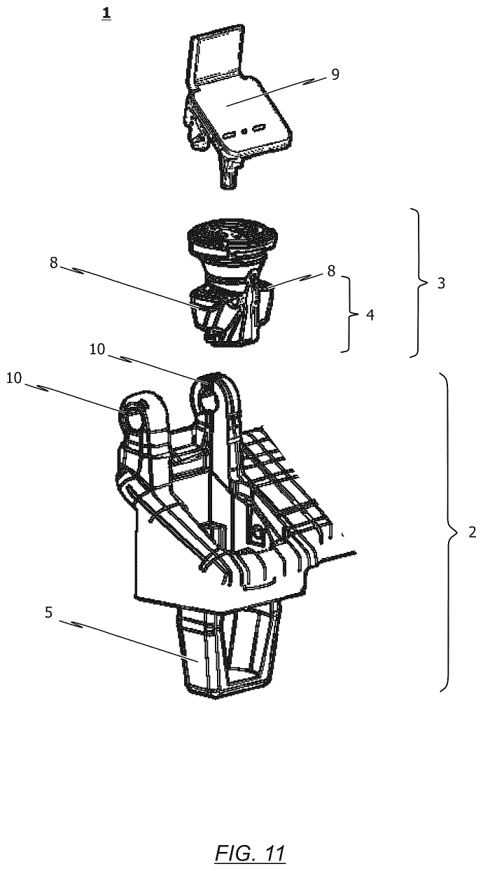

A first exemplary embodiment of the assembly 1 according to the disclosure will first be described in the following with reference to the illustrations in FIG. 1 to FIG. 8. FIG. 9 to FIG. 11 show a second exemplary embodiment of the assembly 1.

The present disclosure relates generally to a fastening possibility for fastening a vehicle component, in particular an interior component of a vehicle, to a body component. The vehicle component is in particular a vehicle grab handle. More specifically, the present disclosure relates to an optimized fastening possibility, in particular for fastening a vehicle grab handle or an airbag, to a body-side mounted portion, in particular in the automotive sector. The body-side mounted portion is also referred to here as a “vehicle body component.” In principle, with the bolting of a vehicle grab handle to the vehicle body that is currently still customary, the mounting effort is relatively high.

An underlying problem of the present disclosure is to specify a fastening possibility for a vehicle component, in particular an interior component, to a body component, wherein the vehicle component, which is in particular a vehicle grab handle or an airbag, can be fastened to the body component in a particularly easy-to-implement manner, wherein the interior component can be fastened to the body component at least with reduced play and preferably without play, even in case of different sheet thicknesses of the body component and/or in case of tolerance-based deviations.

In particular, a lasting, high-quality connection between the vehicle component, for example the vehicle grab handle, and the vehicle body is to be achievable with as little mounting effort as possible.

Accordingly, an assembly for providing a fastening possibility for a vehicle component, in particular an interior component, to a body component is proposed, wherein the assembly comprises a connecting element, preferably made of a plastic material, with which the vehicle component is connectable. This is, for example, a connecting element with a bearing block region, which serves to pivotally receive the handle part of the vehicle grab handle. Of course, other embodiments can also be considered here.

The assembly according to the disclosure further comprises a retaining element, which is also preferably formed from a plastic material and which serves to retain the connecting element on the body component.

In the assembly according to the disclosure, it is provided that the retaining element comprises a base body having a retaining region. In a similar manner, the connecting element also comprises a base body having an in particular cage-like receiving region, in which at least the retaining region of the retaining element is or can be at least partially or regionally received, namely such that the retaining element, or the retaining region of the retaining element, is rotatable relative to the receiving region about an axis of rotation.

The assembly according to the disclosure can be transferred from a pre-assembly or deliverable state into an assembled state.

According to design variants of the assembly, it is provided according to the disclosure that, in the pre-assembly or deliverable state of the assembly, the retaining element or at least the retaining region of the retaining element lies counter to a torsion torque acting as a biasing force and exerted by a biased torsion spring on the retaining element in a first rotational position relative to the receiving region of the connecting element.

In the assembled state of the assembly, on the other hand, the retaining element or at least the retaining region of the retaining element lies in a second rotational position that is different from the first rotational position.

In particular, it is provided that the assembly can be transferred from its pre-assembly or deliverable state into its assembled state due to an external pulse or trigger exerted on the retaining element.

In particular, the assembly according to this design variant is wherein, upon transfer of the assembly from its pre-assembly or deliverable state into its assembled state, the retaining element or at least the retaining region of the retaining element is at least partially transferred, and in particular is rotated, into the second rotational position by the force of the torsion spring.

According to implementations of the assembly according to the disclosure, it is provided that the assembly comprises a catching or locking device, which, in the pre-assembly or deliverable state of the assembly, is configured to hold or lock the retaining element or at least the retaining region of the retaining element, counter to the torsion torque exerted by the biased torsion spring on the retaining element, in the first rotational position relative to the receiving region of the connecting element.

In this context, it is contemplated in particular that the catching or locking device is configured to lift a locking of the retaining element or at least of the retaining region of the retaining element in the first rotational position when the external pulse or trigger is exerted on the retaining element.

According to design variants of the assembly according to the disclosure, it is provided that the assembly is configured such that, in the pre-assembly or deliverable state of the assembly, the receiving region of the connecting element, with the retaining region of the retaining element at least partially or regionally received therein, can be inserted into the body component at least partially or regionally through a fastening opening.

In this context in particular, it can be appreciated that by exerting a predefined or definable minimum force on the retaining element in a direction in which the receiving region of the connecting element with the retaining region of the retaining element least partially or regionally received therein can be inserted through the fastening opening in the body component, the assembly is transferred from its pre-assembly or deliverable state into its assembled state.

Various embodiments can be considered with respect to the torsion spring. For example, it is contemplated in particular that the torsion spring is configured as a torsion rod. However, a coil spring, and in particular a coil spring made from metal, is preferably contemplated as the torsion spring.

To mount the assembly itself, i.e. to assemble the composition, it is preferred that the base body of the connecting element comprises a receiving opening into which the retaining element can be at least regionally received or inserted, preferably together with the biased torsion spring.

According to implementations of the assembly according to the disclosure, it is provided that the in particular cage-like receiving region of the base body of the connecting element preferably comprises two opposing window regions, and preferably two at least partially or regionally radially projecting wing regions are formed on the retaining region of the base body of the retaining element.

In this context, it can be appreciated that, in the first rotational position of the retaining element or at least the retaining region of the retaining element, the wing regions that radially project from the base body of the retaining element do not project, or at least do not project completely, through the preferably two window regions of the in particular cage-like receiving region, wherein, by contrast, in the second rotational position of the retaining element or at least the retaining region of the retaining element, the preferably two wing regions of the base body of the retaining element project out of the respective window regions of the in particular cage-like receiving region of the connecting element.

Of course, however, the disclosure is not limited to two window regions or two wing regions.

According to an alternative or additional aspect of the disclosure, it is provided that the assembly comprises a state indicator which is configured to indicate the pre-assembly or deliverable state and/or the assembled state of the assembly, or to indicate when the assembly has been transferred from its pre-assembly or deliverable state into its assembled state.

Alternatively or additionally, the disclosure relates to an assembly for providing a fastening possibility for a vehicle component, in particular an interior component, to a body component, wherein the assembly is designed in particular as a torsion clip and comprises a connecting element made of a plastic material, to which the vehicle component is connectable, and a retaining element, preferably made of a plastic material, for holding the connecting element on the body component.

In this alternative or additional design variant, it is once again provided that the retaining element comprises a base body having a retaining region and that the connecting element comprises a base body having a receiving region, which is in particular cage-like in design, in which the retaining region of the retaining element is or can be rotatably received at least partially or regionally relative to the receiving region about an axis of rotation.

It is likewise provided that the assembly can be transferred from a pre-assembly or deliverable state into an assembled state.

The alternative or additional aspect of the disclosure is characterized in particular in that a receiving opening is configured in the base body of the connecting element, via which at least the retaining region of the retaining element can be inserted into the in particular cage-like receiving region of the connecting element.

It is further provided that the assembly comprises a cover, which, at least in the assembled state of the assembly, is configured to cover the receiving opening preferably flush, and in particular strake-flush, in relation to an edge region of the base body of the connecting element surrounding the receiving opening.

In this context, it can be appreciated that the cover itself is configured as a state indicator, wherein, when the assembly is transferred from its pre-assembly or deliverable state into its assembled state, the cover is automatically transferred into its position closing the receiving opening, in which position the cover is arranged in particular to be flush, and preferably strake-flush, in relation to the edge region of the base body of the connecting element surrounding the receiving opening.

According to design variants of the assembly according to the disclosure, it is provided in particular that, in the pre-assembly or deliverable state of the assembly, the cover is retained in a first position relative to the connecting element with the aid of at least one catching or locking element, wherein, by exerting a critical force on the cover, a catching or locking effect of the at least one catching or locking element can be overcome, and the assembly can be transferred into its assembled state.

In particular, the retaining element is mounted to be rotatable about an axis of rotation relative to the connecting element and relative to the cover.

In this context, it can be appreciated that the cover comprises guide means, in particular in the form of at least one guide pin, wherein the retaining element comprises guide means which are designed to be at least partially or regionally complementary to the guide means of the cover, in particular in the form of at least one guide groove, in which the guide means of the cover are at least partially or regionally received.

In particular, it is provided that the guide means of the cover and the guide means of the retaining element are designed and cooperate with one another in such a manner that, when the assembly is transferred from the pre-assembly or deliverable state into the assembled state, the cover is transferred into the position that is flush, and preferably strake-flush, in relation to the edge region of the base body of the connecting element surrounding the receiving opening.

In particular according to preferred implementations of the last mentioned design variant of the assembly according to the disclosure, it is provided that, in order to transfer the assembly from the pre-assembly or deliverable state into the assembled state, the cover can be moved relative to the retaining element and relative to the connecting element in the direction in which the receiving region of the connecting element with the retaining region of the retaining element at least partially or regionally received therein can be inserted through a fastening opening in the body component.

According to realizations of the assembly according to the disclosure, it is provided that, in the receiving region of the connecting element, an at least partially or regionally channel-like or groove-like guide system is configured, and wherein a guide region designed in particular as a radial projection is configured on the base body of the retaining element and correspondingly interacts with the guide system of the receiving region of the connecting element upon transfer of the assembly from the pre-assembly or deliverable state into the assembled state of the assembly.

It is preferably provided in this context that the guide system of the receiving region of the connecting element is configured in a self-inhibiting manner such that, after the transfer of the assembly into the assembled state, the guide system locks or blocks a return transfer of the assembly back into the pre-assembly or deliverable state.

Such a lock or block can be preferably lifted, as needed. In this context, it is provided in particular that, with the aid of an external manipulation tool, the lock or block of the guide system can be lifted as needed.

According to design variants of the assembly according to the disclosure, it is furthermore provided that the retaining element comprises a locking element, which is designed to be in particular at least partially or regionally elastic, which is configured to hold the retaining element in the first rotational position in the pre-assembly or deliverable state of the assembly, at least until a force is exerted on the retaining element that is critical for lifting this state.

Preferably, the preferably two at least partially or regionally radially projecting wing regions of the retaining element are configured to clamp a sheet or body component between the wing regions and the connecting element, preferably a flange projection of the connecting element, upon transfer of the assembly from the pre-assembled or delivered state.

The assembly 1 according to the disclosure is a fastening apparatus for a vehicle part, in particular a vehicle interior part, such as a vehicle grab handle. This is an optimized fastening possibility for fastening a vehicle interior part to a body-side mounted portion, in particular to a vehicle body component.

The exemplary embodiments of the assembly 1 according to the disclosure as shown in the drawings each comprise a retaining element 3, preferably made of a plastic material. The retaining element 3 serves to hold a connecting element onto a body component. The connecting element is likewise preferably made from a plastic material. A bearing block 10 is molded on the connecting element, with which the vehicle component, for example the vehicle grab handle, can be connected.

The retaining element 3 comprises a base body having a retaining region 4. In the exemplary embodiments of the assembly 1 according to the disclosure as shown in the drawings, two at least partially or regionally radially projecting wing regions 8 are configured on the retaining region 4 of the base body of the retaining element 3.

The connecting element 2 also comprises a base body having a receiving region 5, which is designed in a cage-like manner. Specifically, in the exemplary embodiments of the assembly 1 according to the disclosure as shown in the drawings, it is provided that the in particular cage-like receiving region 5 of the base body of the connecting element 2 comprises two opposing window regions.

In the in particular cage-like receiving region 5 of the base body of the connecting element 2, the retaining region 4 of the retaining element 3 is received at least partially or regionally in a rotatable manner relative to the receiving region 5 about an axis of rotation.

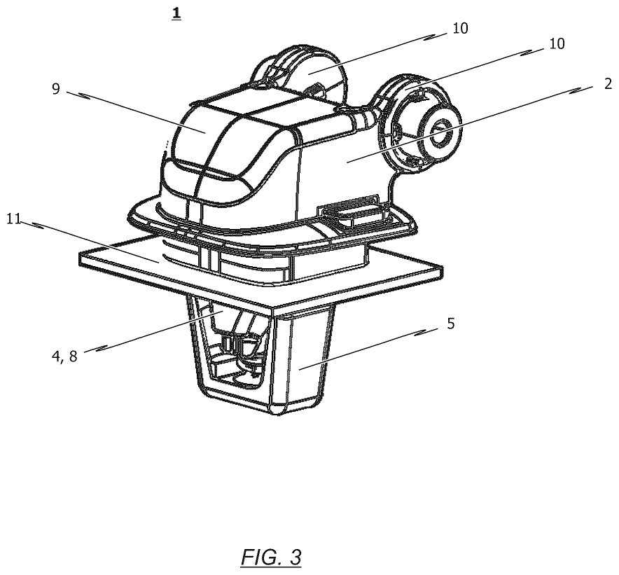

The two exemplary embodiments of the assembly 1 according to the disclosure as shown in the drawings are in particular wherein the assembly 1 can be transferred from a pre-assembly or deliverable state into an assembled state. For example, the pre-assembly or deliverable state of the first exemplary embodiment of the assembly 1 according to the disclosure is shown in FIG. 1. By contrast, FIG. 3 shows the first exemplary embodiment of the assembly 1 according to the disclosure in its assembled state.

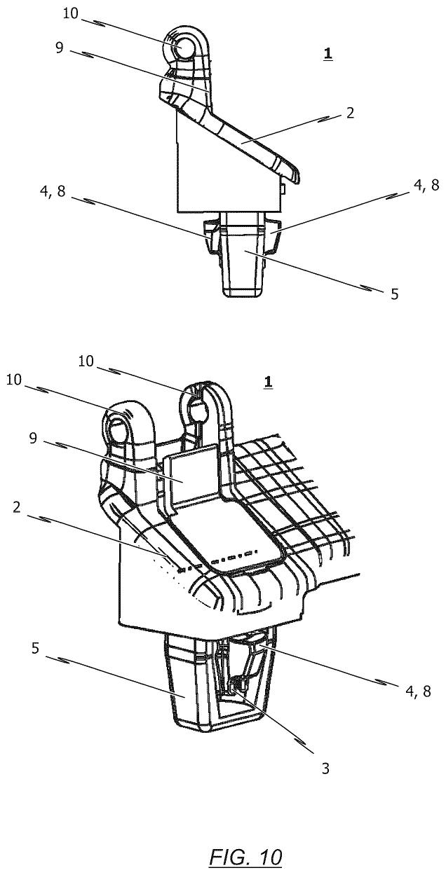

With regard to the second exemplary embodiment of the assembly 1 according to the present disclosure, it is shown in FIG. 9 in its pre-assembly or deliverable state, while FIG. 10 shows the second exemplary embodiment of the assembly 1 in its assembled state.

In the pre-assembly or deliverable state of the assembly 1, the retaining element 3 or at least the retaining region 4 of the retaining element 3 lies counter to a torsion torque acting as a biasing force and exerted by a biased torsion spring 6 on the retaining element 3 in a first rotational position relative to the receiving region 5 of the connecting element 2. In the assembled state of the assembly 1, on the other hand, the retaining element 3 or at least the retaining region 4 of the retaining element 3 lies in a second rotational position that is different from the first rotational position.

In order to transfer the assembly 1 from its pre-assembly or deliverable state into its assembled state, an external pulse or trigger must be exerted on the retaining element 3.

Upon transfer of the assembly 1 from its pre-assembly or deliverable state into its assembled state, the retaining element 3 or at least the retaining region 4 of the retaining element 3 is at least partially transferred, and in particular is rotated, into the second rotational position by the force of the torsion spring 6.

In the pre-assembly or deliverable state of the assembly 1, the receiving region 5 of the connecting element 2, with the retaining region 4 of the retaining element 3 at least partially or regionally received therein, can be inserted into the body component 11 at least partially or regionally through a fastening opening.

After the receiving region 5 of the connecting element 2 with the retaining region 4 of the retaining element 3 received therein has been at least partially or regionally inserted through the fastening opening in the body component 11 in the pre-assembly or deliverable state of the assembly 1, the assembly 1 is transferred from its pre-assembly or deliverable state into its assembled state due to the exertion of an external pulse or trigger on the retaining element 3. The retaining region 4 of the retaining element 3 is at least partially transferred/rotated into the second rotational position.

In the first rotational position of the retaining element 3, i.e. in the pre-assembly or deliverable state of the assembly 1, the wing regions 8 radially projecting from the base body of the retaining element 3 do not project, or at least not project completely, through the preferably two window regions of the in particular cage-like receiving region 5. In the second rotational position of the retaining element 3, i.e. in the assembled state of the assembly 1, on the other hand, the preferably two wing regions 8 of the base body of the retaining element 3 project out of the respective window regions of the in particular cage-like receiving region 5 of the connecting element 2.

The preferably two at least partially or regionally radially projecting wing regions 8 of the retaining element 3 are configured to clamp a sheet or body component 11 between the wing regions 8 and the connecting element 2, preferably a flange projection of the connecting element 2, upon transfer of the assembly 1 from the pre-assembled or delivered state.

In the first exemplary embodiment of the assembly 1 according to the disclosure, it comprises a coil spring, in particular a coil spring made of metal, with which the retaining element 3 is held in a biased manner in the first rotational position in the pre-assembly or deliverable state of the assembly 1. The coil spring serving as a torsion spring 6 is at least regionally received or inserted together with the retaining element 3 via a receiving opening of the base body of the connecting element 2.

The exemplary embodiments of the assembly 1 according to the present disclosure further comprise a state indicator, which is configured to indicate the pre-assembly or deliverable state of the assembly 1 and the assembled state of the assembly 1.

Specifically, it is provided that a receiving opening is configured in the base body of the connecting element 2, via which at least the retaining region 4 of the retaining element 3 can be inserted into the in particular cage-like receiving region 5 of the connecting element 2. The assembly 1 further comprises a cover 9, which, at least in the assembled state of the assembly 1, is configured to cover the receiving opening preferably flush, and in particular strake-flush, in relation to an edge region of the base body of the connecting element 2 surrounding the receiving opening.

The cover 9 is configured as a state indicator. Specifically, upon transfer of the assembly 1 from its pre-assembly or deliverable state into its assembled state, the cover 9 is automatically transferred into its position which closes the receiving opening. In particular, the cover 9 is transferred into a position that is flush, and preferably strake-flush, in relation to the edge region of the base body of the connecting element 2 surrounding the receiving opening.

Specifically, it is provided that the retaining element 3 is mounted to be rotatable about an axis of rotation relative to the connecting element 2 and relative to the cover 9.

The assembly 1 according to the disclosure, as shown in the drawings by way of exemplary embodiments, comprises a corresponding catching or locking device 7, which, in the pre-assembly or deliverable state of the assembly 1, is configured to hold or lock the retaining clement 3 or at least the retaining region 4 of the retaining element 3, counter to the torsion torque exerted by the biased torsion spring 6 on the retaining element 3, in the first rotational position relative to the receiving region 5 of the connecting element 2.

In particular, the catching or locking device 7 is configured to lift a locking of the retaining element 3 or at least of the retaining region 4 of the retaining element 3 in the first rotational position when the external pulse or trigger is exerted on the retaining element 3.

Specifically, for example, in the first exemplary embodiment of the assembly 1 according to the disclosure, the catching or locking device 7 is part of a guide system 15.

An in particular at least partially or regionally channel-like or groove-like guide system 15 is configured in the receiving region 5 of the connecting element 2. At the same time, a guide region 16, designed in particular as a radial projection, is configured on the base body of the retaining element 3. Upon transfer of the assembly 1 from the pre-assembly or deliverable state into the assembled state, there is an interaction between the guide region 16 of the retaining clement 3, which is in particular configured as a radial projection, and the guide system 15 of the receiving region 5 of the connecting element 2.

The guide system 15 is configured such that a locking of the retaining element 3 or at least the retaining region 4 of the retaining element 3 takes place via the guide system 15 in the first rotational position in the pre-assembly or deliverable state of the assembly 1.

The guide system 15 of the receiving region 5 of the connecting element 2 is configured in a self-inhibiting manner such that, after the transfer of the assembly 1 into the assembled state, the guide system 15 locks or blocks a return transfer of the assembly 1 back into the pre-assembly or deliverable state. For this purpose, with the aid of an external manipulation tool, the lock or block of the guide system 15 can be lifted as needed.

According to a preferably alternative design variant, the retaining element 3 can also comprise a locking element, in particular designed to be in particular at least partially or regionally elastic, which is configured to hold the retaining element 3 in the first rotational position in the pre-assembly or deliverable state of the assembly 1. By exerting an external pulse or trigger on the retaining element 3, the elastically designed locking element can be elastically deformed to the extent that the block of the retaining element 3 is lifted in the first rotational position.

In the second exemplary embodiment of the assembly 1 according to the disclosure, the cover 9 can be pivoted about a pivot axis, relative to the retaining element 3 and relative to the connecting element 2, from a first position into a second position. This pivoting motion exerts a torque on the retaining element 3, so that it is transferred/rotated from its first position into the second position.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Assembly
2 Connecting element
3 Retaining element
4 Retaining region
Receiving region
6 Torsion spring
7 Catching/locking device
8 Wing regions of the retaining element
9 Cover/state indicator
Bearing block
11 Body component
12 Catching/locking device element of the cover
13 Guide means of the cover
14 Guide means of the retaining part
Guide system
16 Guide region

What is claimed is:

1. An assembly (1) for providing a fastening possibility for a vehicle component to a body component (11), wherein the assembly (1) is configured as a torsion clip and comprises the following:
a connecting element (2) made of a plastic material to which the vehicle component is connectable; and
a retaining element (3) made of a plastic material for retaining the connecting element (2) on the body component (11),
wherein the retaining element (3) comprises a base body having a retaining region (4), and wherein the connecting element (2) comprises a base body having a receiving region (5), which is cage-like in design, in which at least the retaining region (4) of the retaining element (3) is or can be rotatably received at least partially or regionally relative to the receiving region (5) about an axis of rotation, and wherein the assembly (1) can be transferred from a pre-assembly or deliverable state into an assembled state,
wherein in the pre-assembly or deliverable state of the assembly (1), the retaining element (3) or at least the retaining region (4) of the retaining element (3) lies in a first rotational position relative to the receiving region (5) of the connecting element (2) counter to a torsion torque serving as a biasing force and exerted by a biased torsion spring (6) on the retaining element (3), wherein, in the assembled state of the assembly (1), the retaining element (3) or at least the retaining region (4) of the retaining element (3) lies in a second rotational position that is different from the first rotational position, and wherein, due to an external pulse or trigger exerted on the retaining element (3), the assembly (1) can be transferred from its pre-assembly or deliverable state into its assembled state, wherein, when the assembly (1) is transferred from its pre-assembly or deliverable state into its assembled state, the retaining element (3) or at least the retaining region (4) of the retaining element (3) is at least partially transferred, and is rotated, into the second rotational position due to the force of the torsion spring (6).

2. The assembly (1) according to claim 1,
wherein the assembly (1) comprises a catching or locking device (7), which, in the pre-assembly or deliverable state of the assembly (1), is configured to hold or lock the retaining element (3) or at least the retaining region (4) of the retaining element (3), counter to the torsion torque exerted by the biased torsion spring (6) on the retaining element (3), in the first rotational position relative to the receiving region (5) of the connecting element (2).

3. The assembly (1) according to claim 2,
wherein the catching or locking device (7) is configured to lift a locking of the retaining element (3) or at least of the retaining region (4) of the retaining element (3) in the first rotational position when the external pulse or trigger is exerted on the retaining element (3).

4. The assembly (1) according to claim 1, wherein the assembly (1) is configured such that, in the pre-assembly or deliverable state of the assembly (1), the receiving region (5) of the connecting element (2), with the retaining region (4) of the retaining element (3) at least partially or regionally received therein, can be inserted into the body component (11) at least partially or regionally through a fastening opening.

5. The assembly (1) according to claim 4, wherein, by exerting a predefined or definable minimum force on the retaining element (3) in a direction in which the receiving region (5) of the connecting element (2) with the retaining region (4) of the retaining element (3) at least partially or regionally received therein can be inserted into the body component (11) through a fastening opening, the assembly (1) can be transferred from its pre-assembly or deliverable state into its assembled state.

6. The assembly (1) according to claim 1, wherein the torsion spring (6) is configured as a torsion rod, or as a coil spring made of metal.

7. The assembly (1) according to claim 1, wherein the base body of the connecting element (2) comprises a receiving opening into which the retaining element (3) can be at least regionally received or inserted together with the biased torsion spring (6).

8. The assembly (1) according to claim 1, wherein the cage-like receiving region (5) of the base body of the connecting element (2) comprises two opposing window regions, and wherein two at least partially or regionally radially projecting wing regions (8) are formed on the retaining region (4) of the base body of the retaining element (3), wherein, in the first rotational position of the retaining element (3) or at least the retaining region (4) of the retaining element (3), the wing regions (8) that radially project from the base body of the retaining element (3) do not project, or at least do not project completely, through the two window regions of the cage-like receiving region (5), wherein, by contrast, in the second rotational position of the retaining element (3) or at least the retaining region (4) of the retaining element (3), the two wing regions (8) of the base body of the retaining element (3) project out of the respective window regions of the cage- like receiving region (5) of the connecting element (2).

9. The assembly (1) according to claim 1, wherein the assembly (1) comprises a state indicator which is configured to indicate the pre-assembly or deliverable state and/or the assembled state of the assembly (1), or to indicate when the assembly (1) has been transferred from its pre-assembly or deliverable state into its assembled state.

10. The assembly (1) according to claim 1, wherein a receiving opening is formed in the base body of the connecting element (2), via which at least the retaining region (4) of the retaining element (3) can be inserted into the cage-like receiving region (5) of the connecting element (2), wherein the assembly (1) further comprises a cover (9), which, at least in the assembled state of the assembly (1), is configured to cover the receiving opening flush, and strake-flush, in relation to an edge region of the base body of the connecting element (2) surrounding the receiving opening.

11. The assembly (1) according to claim 10, wherein the cover (9) is configured as a state indicator, and wherein, when the assembly (1) is transferred from its pre-assembly or deliverable state into its assembled state, the cover (9) is automatically transferred into its position closing the receiving opening, and into a position that is flush, and strake-flush, in relation to the edge region of the base body of the connecting element (2) surrounding the receiving opening.

12. The assembly (1) according to claim 11, wherein, in the pre-assembly or deliverable state of the assembly (1), the cover (9) is retained in a first position relative to the connecting element (2) with the aid of at least one catching or locking element (12), wherein, by exerting a critical force, a catching or locking effect of the at least one catching or locking element (12) can be overcome, and the assembly (1) can be transferred into its assembled state.

13. The assembly (1) according to claim 10, wherein the retaining element (3) is mounted to be rotatable or pivotable about an axis of rotation relative to the connecting element (2) and relative to the cover (9).

14. The assembly (1) according to claim 13, wherein the cover (9) comprises guide means (13), in the form of at least one guide pin, and wherein the retaining element (3) comprises guide means (14) which are designed to be at least partially or regionally complementary to the guide means (13) of the cover (9), in the form of at least one guide groove, in which the guide means (13) of the cover (9) are at least partially or regionally received, wherein the guide means (13) of the cover (9) and the guide means (14) of the retaining element (3) are designed and cooperate with one another in such a manner that, when the assembly (1) is transferred from the pre-assembly or deliverable state into the assembled state, the cover (9) is transferred into the position that is flush in relation to the edge region of the base body of the connecting element (2) surrounding the receiving opening.

15. The assembly (1) according to claim 5, wherein, in order to transfer the assembly (1) from the pre-assembly or deliverable state into the assembled state, the cover (9) can be moved relative to the retaining element (3) and relative to the connecting element (2) in the direction in which the receiving region (5) of the connecting element (2) with the retaining region (4) of the retaining element (3) at least partially or regionally received therein can be inserted through a fastening opening in the body component (11).

16. The assembly (1) according to claim 1, wherein, in the receiving region (5) of the connecting element (2), an at least partially or regionally channel-like or groove-like guide system (15) is configured, and wherein a guide region (16) designed as a radial projection is configured on the base body of the retaining element (3) and interacts with the guide system (15) of the receiving region (5) of the connecting element (2) upon transfer of the assembly (1) from the pre-assembly or deliverable state into the assembled state.

17. The assembly (1) according to claim 16, wherein the guide system (15) of the receiving region (5) of the connecting element (2) is configured in a self-inhibiting manner such that, after the transfer of the assembly (1) into the assembled state, the guide system (15) locks or blocks a return transfer of the assembly (1) back into the pre-assembly or deliverable state.

18. The assembly (1) according to claim 17, wherein, with the aid of an external manipulation tool, the lock or block of the guide system (15) can be lifted as needed.

19. The assembly (1) according to claim 1, wherein the retaining element (3) comprises a locking element, designed to be at least partially or regionally elastic, which is configured to hold the retaining element (3) in the first rotational position in the pre-assembly or deliverable state of the assembly (1).

20. The assembly (1) according to claim 8, wherein the two at least partially or regionally radially projecting wing regions (8) of the retaining element (3) are configured to clamp a sheet or body component (11) between the wing regions and the connecting element (2), a flange projection of the connecting element (2), upon transfer of the assembly (1) from the pre-assembled or delivered state.
